(19) United States
(12) Patent Application Publication
(10) Pub. No.: US 2026/0021538 A1
(43) Pub. Date: Jan. 22, 2026

(54) LASER PROCESSING APPARATUS

(71) Applicant: Samsung Display Co., Ltd., Yongin-Si (KR)

(72) Inventors: Akifumi SANGU, Yongin-si (KR); Kang Hyuk LEE, Yongin-si (KR)

(21) Appl. No.: 19/244,268

(22) Filed: Jun. 20, 2025

(30) Foreign Application Priority Data
Jul. 22, 2024 (KR) 10-2024-0096457

(51) Int. Cl. B23K 26/06

(52) U.S. Cl. CPC B23K 26/0643

(57) ABSTRACT

A laser processing apparatus according to an embodiment of the present disclosure includes a beam generator generating incident light, and a light converter arranged in an optical path of the incident light and converting the incident light into a plurality of output lights having different outputs. The light converter may include a first optical member having a first reflectivity, a second optical member having a second reflectivity different from the first reflectivity, and a first moving member supporting the first optical member and the second optical member. The first moving member may operate in a first mode in which the first optical member is arranged in the optical path of the incident light and operate in a second mode in which the second optical member is arranged in the optical path of the incident light.

### CROSS-REFERENCE TO RELATED APPLICATION

This application claims priority under 35 U.S.C. § 119 to Korean Patent Application No. 10-2024-0096457, filed on Jul. 22, 2024, in the Korea Intellectual Property Office, the entire contents of which are incorporated herein by reference.

### BACKGROUND

### 1. Technical Field

The present disclosure relates to a laser processing apparatus.

### 2. Related Art

A display device displays an image to provide visual information to a user. The display device is used in a variety of ways, from a display for small products such as mobile phones to a display for large products such as televisions.

Lasers may be used in a manufacturing process of the display device. As a high-density heat source, the laser may be used for marking workpieces, cutting according to patterns, welding or heat-treating workpieces, or the like. A laser processing has the advantages of its non-contact nature, the low wear, and the ability to perform precision processing.

The above description is only intended to help understand the background of the technical ideas of the present disclosure. Therefore, it is understood that the above description would not constitute prior arts known to those skilled in the art to which the present disclosure pertains.

### SUMMARY

The present disclosure is to provide a laser processing apparatus capable of processing different workpieces using a single optical system.

However, the feature of the present disclosure is not limited to the description above, and other technical features not mentioned above will be clearly understood by those skilled in the art from the following description.

According to an embodiment of the present disclosure, a laser processing apparatus includes a beam generator generating incident light, and a light converter arranged in an optical path of the incident light and converting the incident light into a plurality of output lights having different outputs. The light converter may include a first optical member having a first reflectivity, a second optical member having a second reflectivity different from the first reflectivity, and a first moving member supporting the first optical member and the second optical member. The first moving member may operate in a first mode in which the first optical member is arranged in the optical path of the incident light and operate in a second mode in which the second optical member is arranged in the optical path of the incident light.

The laser processing apparatus may further include a beam expander disposed between the beam generator and the light converter.

When the first moving member operates in the first mode, the first optical member may reflect a portion of the incident light corresponding to the first reflectivity as first reflected light, and transmit a remaining portion of the incident light excluding the first reflected light as first transmitted light. The light converter may further include a first absorbing member absorbing the first reflected light.

The light converter may further include a compensation member arranged on a downstream side of the first optical member and adjusting an optical path of the first transmitted light incident from the first optical member. The compensation member may convert the first transmitted light into a first output light having a first output.

The compensation member may include a third optical member having a third reflectivity, a fourth optical member having a fourth reflectivity different from the third reflectivity, and a second moving member supporting the third optical member and the fourth optical member. The second moving member may operate in a third mode in which the third optical member is arranged in the optical path of the first transmitted light and operate in a fourth mode in which the fourth optical member is arranged in the optical path of the first transmitted light.

When the second moving member operates in the third mode, the third optical member may reflect a portion of the first transmitted light corresponding to the third reflectivity as second reflected light, and transmit a remaining portion of the first transmitted light excluding the second reflected light as a second output light having a second output. The fourth optical member may reflect a portion of the second reflected light corresponding to the fourth reflectivity as third reflected light, and transmit a remaining portion of the second reflected light excluding the third reflected light as second transmitted light. The light converter may further include a second absorbing member absorbing the second transmitted light and a third absorbing member absorbing the third reflected light.

When the second moving member operates in the fourth mode, the fourth optical member may reflect a portion of the first transmitted light corresponding to the fourth reflectivity as fourth reflected light, and transmit a remaining portion of the first transmitted light excluding the fourth reflected light as a third output light having a third output.

The light converter may further include a second absorbing member absorbing the fourth reflected light.

When the first moving member operates in the second mode, the second optical member may reflect a portion of the incident light corresponding to the second reflectivity as second reflected light, and transmit a remaining portion of the incident light excluding the second reflected light as second transmitted light. The first optical member may reflect a portion of the second reflected light corresponding to the first reflectivity as third reflected light, and transmit a remaining portion of the second reflected light excluding the third reflected light as third transmitted light. The light converter may further include a first absorbing member absorbing the third transmitted light and a second absorbing member absorbing the third reflected light.

The light converter may further include a compensation member arranged on a downstream side of the second optical member and adjusting an optical path of the second transmitted light incident from the second optical member. The compensation member may convert the second transmitted light into a fourth output light having a fourth output.

The compensation member may include a third optical member having a third reflectivity, a fourth optical member having a fourth reflectivity different from the third reflectivity, and a second moving member supporting the third optical member and the fourth optical member. The second moving member may operate in a fifth mode in which the third optical member is arranged in the optical path of the second transmitted light and operate in a sixth mode in which the fourth optical member is arranged in the optical path of the second transmitted light.

When the second moving member operates in the fifth mode, the third optical member may reflect a portion of the second transmitted light corresponding to the third reflectivity as fourth reflected light, and convert a remaining portion of the second transmitted light excluding the fourth reflected light into a fifth output light having a fifth output. The fourth optical member may reflect a portion of the fourth reflected light corresponding to the fourth reflectivity as fifth reflected light, and transmit a remaining portion of the fourth reflected light excluding the fifth reflected light as fourth transmitted light. The light converter may further include a third absorbing member absorbing the fourth transmitted light and a fourth absorbing member absorbing the fifth reflected light.

When the second moving member operates in the sixth mode, the fourth optical member may reflect a portion of the second transmitted light corresponding to the fourth reflectivity as sixth reflected light, and transmit a remaining portion of the second transmitted light excluding the sixth reflected light as a sixth output light having a sixth output. The light converter may further include a third absorbing member absorbing the sixth reflected light.

According to an embodiment of the present disclosure, a laser processing apparatus includes a beam generator generating incident light, and a light converter arranged in an optical path of the incident light and converting the incident light into one of first output light having a first output and second output light having a second output different from the first output. The light converter may include a first optical member having a first reflectivity, reflecting a portion of the incident light corresponding to the first reflectivity as first reflected light, and transmitting a remaining portion of the incident light excluding the first reflected light as first transmitted light, a first mirror totally reflecting the first reflected light and outputting second reflected light, a second mirror totally reflecting the first transmitted light and outputting third reflected light, a second optical member having a second reflectivity different from the first reflectivity and arranged on a downstream side of the first mirror and the second mirror, and a third mirror movable between a first position and a second position. The first portion may not overlap with an optical path of the second reflected light or the third reflected light, and the second position may overlap with the optical path of the second reflected light or the third reflected light.

When the third mirror is disposed at the first position, the second reflected light may be irradiated onto a first surface of the second optical member, and the third reflected light may be irradiated onto a second surface of the second optical member. The second optical member may reflect a portion of the second reflected light, incident onto the first surface, corresponding to the second reflectivity as fourth reflected light, and transmit a remaining portion of the second reflected light excluding the fourth reflected light as second transmitted light. The second optical member may further reflect a portion of the third reflected light, incident onto the second surface, corresponding to the second reflectivity as fifth reflected light, and transmit a remaining portion of the third reflected light excluding the fifth reflected light as third transmitted light, and may collect the fourth reflected light and the third transmitted light to output the first output light.

The laser processing apparatus may further include a first absorbing member absorbing the second transmitted light and the fifth reflected light.

When the third mirror is disposed at the second position, the second reflected light may be irradiated onto the first surface of the second optical member. The second optical member may reflect a portion of the second reflected light, incident onto the first surface, corresponding to the second reflectivity as the fourth reflected light, and transmit a remaining portion of the second reflected light excluding the fourth reflected light as the second transmitted light. The second optical member may output the fourth reflected light as the second output light.

The third mirror may totally reflect the third reflected light. The laser processing apparatus may further include a second absorbing member absorbing the third reflected light reflected from the third mirror.

According to an embodiment of the present disclosure, a laser processing apparatus includes a beam generator generating incident light, and a light converter arranged in an optical path of the incident light and converting the incident light into one of first output light having a first output and second output light having a second output different from the first output. The light converter may include a first optical member movable between a first posture for converting the incident light into first reflected light directed in a first direction, and a second posture for converting the incident light into second reflected light directed in a second direction different from the first direction, a second optical member having a reflectivity and overlapping the first optical member along the second direction, and a third optical member disposed between the first optical member and the second optical member in an optical path, and totally reflecting the first reflected light in a direction toward the second optical member when the first optical member is in the first posture. When the first optical member is in the first posture, the second optical member may reflect a portion of the first reflected light, output from the third optical member, corresponding to the reflectivity as the first output light, and transmit a remaining portion of the first reflected light excluding the first output light as transmitted light. When the first optical member is in the second posture, the second optical member may reflect a portion of the second reflected light corresponding to the reflectivity as third reflected light, and transmit a remaining portion of the second reflected light excluding the third reflected light as the second output light.

The laser processing apparatus may further include an absorbing member absorbing the transmitted light when the first optical member is in the first posture and absorbing the third reflected light when the first optical member is in the second posture.

The present disclosure is not limited to the examples described above. The present disclosure may extend to other variations or equivalents thereof as those are clearly understood by those skilled in the art to which the present disclosure pertains from this specification and the accompanying drawings.

### BRIEF DESCRIPTION OF THE DRAWINGS

Embodiments of the present disclosure will now be described more fully hereinafter with reference to the accompanying drawings. However, the present disclosure may be implemented in different forms and should not be construed as limited to the embodiments set forth herein. Rather, the embodiments may be variously expanded without departing from the sprit and scope of the present disclosure.

FIG. 1A is a block diagram illustrating a first operating example of a laser processing apparatus according to an embodiment of the present disclosure.

FIG. 1B is a block diagram illustrating a second operating example of the laser processing apparatus according to an embodiment of the present disclosure.

FIGS. 2A to 2D are conceptual diagrams illustrating steps of cutting a substrate using output lights generated from the laser processing apparatus shown in FIGS. 1A and 1B.

FIG. 3A is a block diagram illustrating a first operating example of a laser processing apparatus according to an embodiment of the present disclosure.

FIG. 3B is a block diagram illustrating a second operating example of the laser processing apparatus according to an embodiment of the present disclosure.

FIG. 3C is a block diagram illustrating a third operating example of the laser processing apparatus according to an embodiment of the present disclosure.

FIG. 3D is a block diagram illustrating a fourth operating example of the laser processing apparatus according to an embodiment of the present disclosure.

FIG. 4A is a block diagram illustrating a first operating example of a laser processing apparatus according to an embodiment of the present disclosure.

FIG. 4B is a block diagram illustrating a second operating example of the laser processing apparatus according to an embodiment of the present disclosure.

FIG. 4C is a block diagram illustrating a third operating example of the laser processing apparatus according to an embodiment of the present disclosure.

FIG. 5 is a block diagram illustrating an operating example of a laser processing apparatus according to an embodiment of the present disclosure.

FIG. 6A is a block diagram illustrating a first operating example of a laser processing apparatus according to an embodiment of the present disclosure.

FIG. 6B is a block diagram illustrating a second operating example of the laser processing apparatus according to an embodiment of the present disclosure.

FIG. 7A is a block diagram illustrating a first operating example of a laser processing apparatus according to an embodiment of the present disclosure.

FIG. 7B is a block diagram illustrating a second operating example of the laser processing apparatus according to an embodiment of the present disclosure.

### DETAILED DESCRIPTION

Hereinafter, embodiments of the present disclosure are described in more detail with reference to the accompanying drawings. It should be noted that in the following description, only the parts necessary to understand the present disclosure will be described, and descriptions with regard to irrelevant parts will be omitted. In addition, the present disclosure is not limited to the embodiments described herein and may be implemented in various forms. The embodiments described herein are provided merely to explain the present disclosure in detail in order for those skilled in the art to easily practice the present disclosure.

In the present disclosure, it will be understood that when a portion is referred to as being “connected” to another portion, the portion may be not only “directly connected” but also “indirectly connected” to another portion. Terms used herein are only for describing embodiments of the present disclosure and are not intended to limit the present disclosure. For example, the singular expressions are intended to include the plural expressions as well, unless the context clearly indicates otherwise. In addition, it should be understood that terms such as “comprise,” “include,” and “have” as well as their variations such as “including,” when used herein, specify the presence of stated features, numbers, steps, operations, components, parts, or combinations thereof, but do not preclude the presence or addition of one or more other features, numbers, steps, operations, components, parts, or combinations thereof, unless the context clearly indicates otherwise. “At least any one of X, Y, and Z” and “at least any one selected from a group consisting of X, Y, and Z” may be interpreted as one X, one Y, one Z, or any combination of two or more of X, Y, and Z (for example, XYZ, XYY, YZ, and ZZ). Here, “and/or” includes all combinations of one or more of corresponding configurations.

In the present disclosure, it will be understood that, although terms such as first, second, or the like may be used to describe various components, these components should not be limited by the terms. These terms may be used only for distinguishing one component from another component. For example, without departing from the scope of the present disclosure, a first component may refer to a second component, and similarly, the second component may also be referred to as the first component.

Spatially relative terms such as “under”, “on”, or the like may be used for descriptive purposes, thereby describing the relationship of elements illustrated in the drawings. Spatially relative terms are intended to include other directions in use, in operation, and/or in manufacturing, in addition to the direction depicted in the drawings. For example, when a device shown in the drawing is turned upside down, elements depicted as being positioned “under” other elements may be positioned as being “on” the other elements. Therefore, in an embodiment, the term “under” may include both directions of on and under. In addition, the device may face other directions (for example, rotated 90 degrees or in other directions) and thus the spatially relative terms used herein are interpreted according thereto.

Various embodiments are described with reference to drawings schematically illustrating ideal embodiments. Accordingly, it will be expected that shapes may vary, for example, according to tolerances and/or manufacturing techniques. Therefore, the embodiments disclosed herein should not be construed as being limited to the specific shapes shown in the drawings, and should be interpreted as including, for example, various modifications in shapes that may occur as a result of manufacturing. In addition, it should be noted that the shapes of components or elements depicted in the drawings are only for the convenience of the descriptions and may not represent the actual shapes of the components or elements. Accordingly, the embodiments of the present disclosure are not limited to the shapes of the components of elements depicted in the drawings.

In the present disclosure, a plurality of output lights having different outputs means that each of the output lights (or laser beams) generated by a laser processing apparatus according to an embodiment may include different characteristics, including an output power, of each of the output lights (or laser beams).

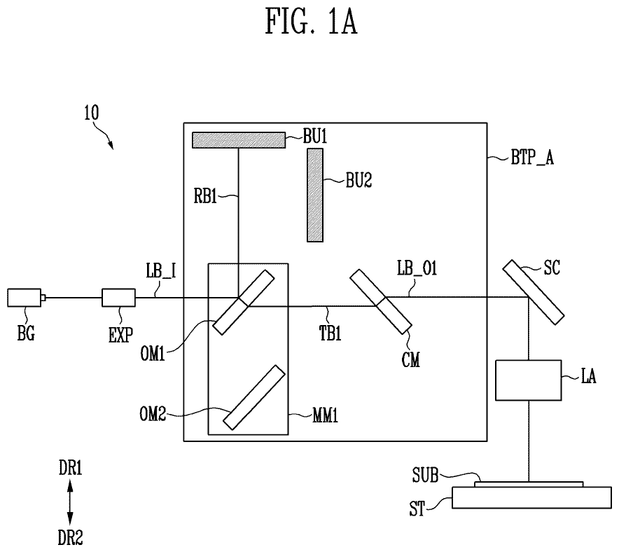

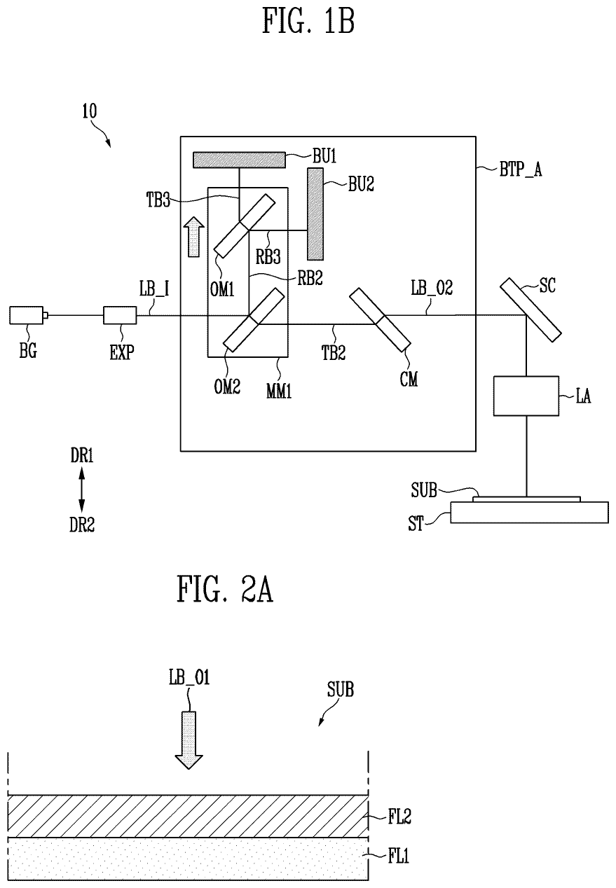

With reference to FIGS. 1A and 1B, components of a laser processing apparatus 10 according to an embodiment and their connection relationships will be described in detail hereinafter.

FIG. 1A is a block diagram illustrating a first operating example of a laser processing apparatus according to an embodiment of the present disclosure. FIG. 1B is a block diagram illustrating a second operating example of the laser processing apparatus according to an embodiment of the present disclosure.

Referring to FIG. 1A, the laser processing apparatus 10 may include a beam generator BG, a beam expander EXP, a light converter BTP_A, a scanner SC, and a lens array LA.

The beam generator BG may generate incident light LB_I and emit the incident light LB_I continuously or discontinuously. The beam generator BG may emit the incident light LB_I with pulses (for example, ultrashort pulses) or burst pulses that have a wavelength, energy, and duration suitable for processing a workpiece.

The wavelength of the incident light LB_I may be 340 nm to 360 nm, but the present disclosure is not necessarily limited thereto. For example, the wavelength of the incident light LB_I may exceed 360 nm. In addition, the emission time of the incident light LB_I may be shorter than 1 nanosecond. For example, the emission time of the incident light LB_I may be tens of picoseconds or tens of femtoseconds, but the present disclosure is not limited thereto. For example, the emission time of the incident light LB_I may be sufficiently long, such as tens of seconds to several minutes.

The beam generator BG may emit a single beam or multi-beams. For convenience of description, the following explanation will focus on a beam generator BG that emits a single beam.

The beam expander EXP may be arranged on a downstream side of the beam generator BG in an optical path. The beam expander EXP may expand the size of the incident light LB_I emitted from the beam generator BG and output the incident light LB_I toward the light converter BTP_A. In addition, the beam expander EXP may modulate the incident light LB_I into a collimated beam with less dispersion or concentration. For example, the beam expander EXP may be implemented with a lens, a light guide plate, an expander plate, or the like that can expand a beam.

The light converter BTP_A may be arranged on a downstream side in an optical path of the incident light LB_I. The light converter BTP_A may convert the incident light LB_I into one of first to n-th output lights having different outputs, where n may be a natural number. Here, one of the first to n-th output lights having different outputs, for example, having different powers or characteristics of each of the first to n-th output lights, may have an output lower than that of the incident light LB_I. In other words, the light converter BTP_A may attenuate the output of the incident light LB_I.

The light converter BTP_A may include a first optical member OM1, a second optical member OM2, a first moving member MM1, a first absorbing member BU1, a second absorbing member BU2, and a compensation member CM.

The first optical member OM1 may be a component having a first reflectivity and may be configured to reflect a portion of the incident light LB_I corresponding to the first reflectivity and transmit the other portion of the remaining incident light LB_I. For example, when the first reflectivity is 95%, the first optical member OM1 may reflect 95% of the incident light LB_I and transmit the remaining 5%.

The first optical member OM1 may be a beam splitter, but the present disclosure is not necessarily limited thereto. For example, the first optical member OM1 may include an optical component suitable for reflecting a portion of the incident light LB_I and transmitting the other portion of the incident light LB_I.

The second optical member OM2 may be a component having a second reflectivity different from the first reflectivity and may be configured to reflect a portion of the incident light LB_I corresponding to the second reflectivity and transmit the other portion of the remaining incident light LB_I. For example, when the second reflectivity is 10%, the second optical member OM2 may reflect 10% of the incident light LB_I and transmit the remaining 90%.

The second optical member OM2 may be a beam splitter, like the first optical member OM1, but embodiments are not limited thereto. The second optical member OM2, like the first optical member OM1, may include an optical component suitable for reflecting a portion of the incident light LB_I and transmitting the other portion of the incident light LB_I.

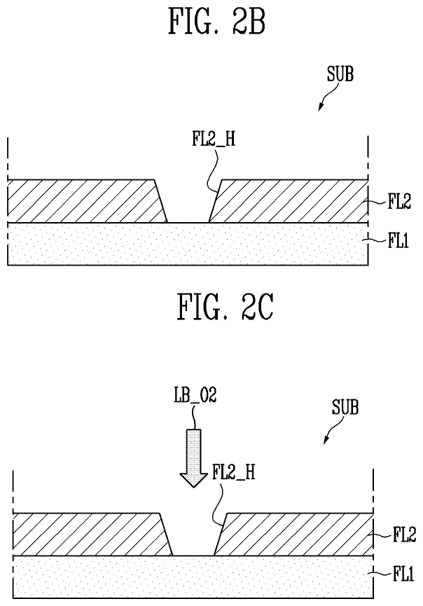

The first moving member MM1 may support the first optical member OM1 and the second optical member OM2 and allow the first optical member OM1 and the second optical member OM2 to move. The first moving member MM1 may operate in either a first mode (see FIG. 1A) in which the first optical member OM1 is arranged in the optical path of the incident light LB_I or a second mode (see FIG. 2A) in which the second optical member OM2 is arranged in the optical path of the incident light LB_I. To this end, the first moving member MM1 may move in a first direction DR1 and a second direction DR2.

FIG. 1A shows a state where the first optical member OM1 is arranged in the optical path of the incident light LB_I. In addition, FIG. 1B shows a state where the second optical member OM2 is arranged in the optical path of the incident light LB_I. In other words, FIG. 1A shows the first moving member MM1 in the first mode, and FIG. 1B shows first moving member MM1 in the second mode. That is, as shown in FIG. 1B, the first moving member MM1 may move in the first direction DR1 from the position of the first moving member MM1 shown in FIG. 1A. Conversely, the first moving member MM1 may move in the second direction DR2 from the position shown in FIG. 1B to the position shown in FIG. 1A. That is, the first moving member MM1 may move in the first direction DR1 or in the second direction DR2 to selectively place the first optical member OM1 or the second optical member OM2, each having different reflectivity, in the optical path of the incident light LB_I.

In FIGS. 1A and 1B, the first moving member MM1 is shown as moving linearly along the first direction DR1 and the second direction DR2, but the embodiment of the present disclosure is not necessarily limited thereto. For example, the first moving member MM1 may rotate to support the first optical member OM1 and the second optical member OM2. That is, the first moving member MM1 may rotate to place the first optical member OM1 in the optical path of the incident light LB_I when operated in the first mode, or to place the second optical member OM2 in the optical path of the incident light LB_I when operated in the second mode. That is, the first moving member MM1 may rotate to selectively arrange the first optical member OM1 or the second optical member OM2 in the optical path of the incident light LB_I.

The first and second absorbing members BU1 and BU2 may absorb reflected light and transmitted light, excluding output light used for processing a substrate SUB. The first and second absorbing members BU1 and BU2 may include a material capable of absorbing light, and may include, for example, a conductive material or an insulating material. As the conductive material forming the first and second absorbing members BU1 and BU2, chromium (Cr), molybdenum (Mo), nickel (Ni), titanium (Ti), cobalt (Co), copper (Cu), or aluminum (Al), an alloy material containing the above-mentioned elements as a main component, a compound (for example, a nitrogen compound, an oxygen compound, a carbon compound, a halogen compound, or the like), or the like may be used, but the present disclosure is not limited thereto.

The compensation member CM may be arranged on a downstream side of the first moving member MM1 in the optical path to compensate for the path of incident light. For example, the compensation member CM may include a compensator that adjusts the path of incident light, but the present disclosure is not limited thereto.

The scanner SC may be arranged on a downstream side of the light converter BTP_A in the optical path. The scanner SC may convert the path of light received from the compensation member CP and provide the light to the lens array LA.

The lens array LA may be arranged on a downstream side of the scanner SC in the optical path. The lens array LA may collect light incident from the scanner SC and irradiate the light onto the substrate SUB disposed on a stage ST.

Hereinafter, with reference to FIGS. 1A and 1B, a detailed explanation will be provided regarding the principle by which the first moving member MM1, by operating in different modes, generates output lights having different outputs.

FIG. 1A shows a state in which the first moving member MM1 operates in the first mode.

Referring to FIG. 1A, the first optical member OM1 may be arranged in the optical path of the incident light LB_1. The first optical member OM1 may reflect a portion of the incident light LB_I corresponding to the first reflectivity as first reflected light RB1, and transmit the other portion of the incident light LB_I, excluding the first reflected light RB1, as first transmitted light TB1.

The first absorbing member BU1 may absorb the first reflected light RB1 reflected by the first optical member OM1. In this way, when the first moving member MM1 is in the first mode, the first absorbing member BU1 may absorb the first reflected light RB1 except for first output light LB_O1 used for processing the substrate SUB. This prevents the reflected light from irradiating other components inside the laser processing apparatus 10, thereby reducing the risk of equipment damage.

The compensation member CM may be arranged on a downstream side of the first optical member OM1 in the optical path to compensate for or adjust an optical path of the first transmitted light TB1 incident from the first optical member OM1. The compensation member CM may convert the first transmitted light TB1 into the first output light LB_O1 having a first output.

FIG. 1B shows a state in which the first moving member MM1 operates in the second mode.

Referring to FIG. 1B, the second optical member OM2 may be arranged in the optical path of the incident light LB_I. This can be implemented by the first moving member MM1 moving a predetermined distance in the first direction DR1 as described above. The second optical member OM2 may reflect a portion of the incident light LB_I corresponding to the second reflectivity as second reflected light RB2, and transmit the other portion of the incident light LB_I excluding the second reflected light RB2 as second transmitted light TB2.

The first optical member OM1 may be arranged on a downstream side of the second optical member OM2 in the optical path. That is, the second reflected light RB2 reflected from the second optical member OM2 may be incident on the first optical member OM1. In this case, the first optical member OM1 may reflect a portion of the second reflected light RB2 corresponding to the first reflectivity as third reflected light RB3, and transmit the other portion of the second reflected light RB2 excluding the third reflected light RB3 as third transmitted light TB3.

When the first moving member MM1 is in the second mode, the first absorbing member BU1 may absorb the third transmitted light TB3, and the second absorbing member BU2 may absorb the third reflected light RB3. The first and second absorbing members BU1 and BU2 may absorb the reflected light except for the light used for processing the substrate SUB. This prevents the reflected light from irradiating other components inside the laser processing apparatus 10, thereby reducing the risk of equipment damage.

The compensation member CM may be arranged on the downstream side of the second optical member OM2 in the optical path to compensate for or adjust an optical path of the second transmitted light TB2 incident from the second optical member OM2. The compensation member CM may convert the second transmitted light TB2 into second output light LB_O2 having a second output.

The laser processing apparatus 10 shown in FIG. 1A and FIG. 1B may constitute a single optical system. According to this structure, the laser processing apparatus 10 may generate the first output light LB_O1 with the first output and the second output light LB_O2 with the second output, and may selectively irradiate either the first output light LB_O1 or the second output light LB_O2, each having different output, onto the processing object.

Hereinafter, with reference to FIGS. 2A to 2D, a detailed explanation will be provided regarding a method of processing a first functional layer FL1 and a second functional layer FL2 of a substrate SUB, by utilizing the first output light LB_O1 or the second output light LB_O2 selectively.

FIGS. 2A to 2D are conceptual diagrams illustrating steps of cutting a substrate using output lights generated from the laser processing apparatus shown in FIGS. 1A and 1B.

Referring to FIGS. 2A to 2D, the substrate SUB may include the first functional layer FL1 and the second functional layer FL2. The first functional layer FL1 and the second functional layer FL2 may be any one of various types of layers or films which forms an element constituting a display device (not shown). For example, each of the first functional layer FL1 and the second functional layer FL2 may be any one of a substrate, a buffer layer, a conductive layer, an insulating layer, a protective layer, an optical filter layer, or a thin film encapsulation layer. For convenience of description, in the following FIGS. 2A to 2D, the first functional layer FL1 may be a substrate, and the second functional layer FL2 may be a protective layer including either organic or inorganic material, as an example.

Referring to FIG. 2A, the first output light LB_O1 having the first output may be irradiated toward the substrate SUB.

Referring to FIG. 2B, a second removed area FL2_H may be formed in the second functional layer FL2 by the first output light LB_O1 irradiated onto the substrate SUB. The second removed area FL2_H may be a hole penetrating the second functional layer FL2, and the cross-section thereof may have a tapered shape that gradually narrows toward the first functional layer FL1.

Referring to FIG. 2C, the second output light LB_O2 having the second output may be irradiated onto a portion of the first functional layer FL1 exposed by the second removed area FL2_H.

Referring to FIG. 2D, a first removed area FL1_H may be formed in the first functional layer FL1 by the second output light LB_O2 irradiated onto a portion of the first functional layer FL1 exposed to the outside. The first removed area FL1_H may be a hole penetrating the first functional layer FL1, and the cross-section thereof may have a constant shape in a thickness direction.

As described above, in order to process different types of a film or layer of different types, such as the first functional layer FL1 and the second functional layer FL2, the laser processing apparatus 10 described with reference to FIGS. 1A and 1B may select either the first output light LB_O1 or the second output light LB_O2, each of which has an output suitable for processing the first functional layer FL1 or the second functional layer FL2, and irradiate the selected light onto the first functional layer FL1 or the second functional layer FL2.

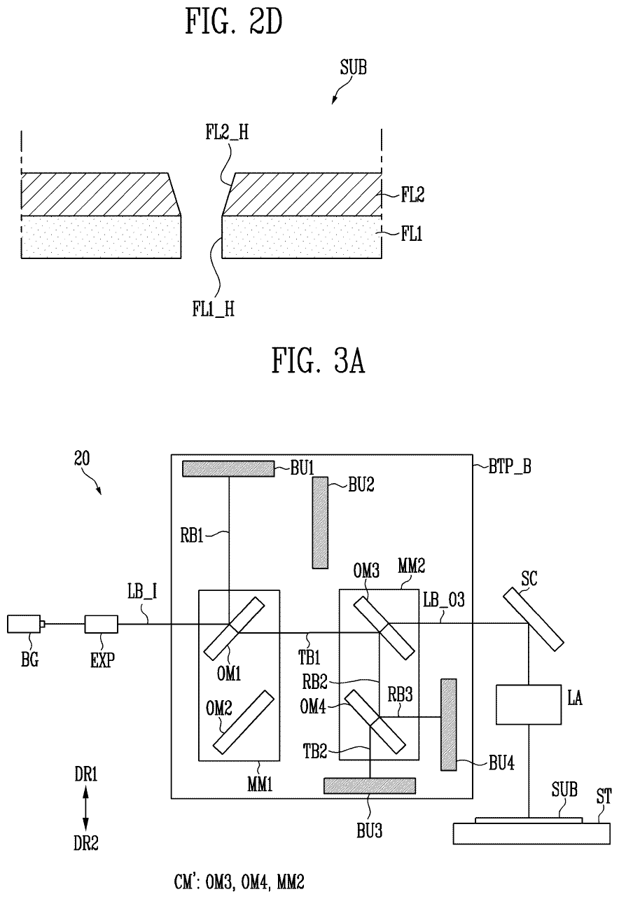

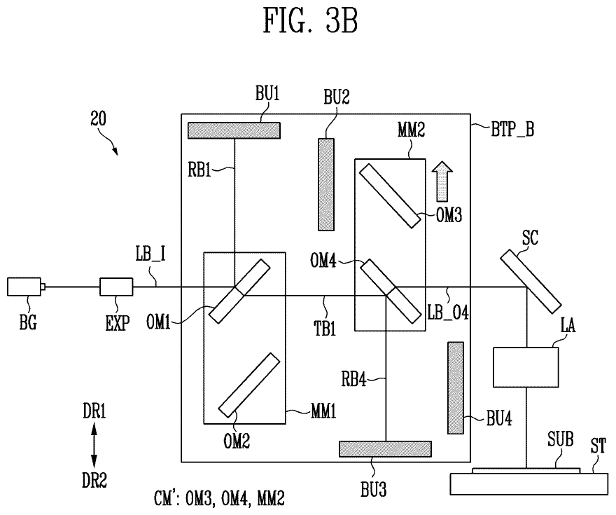

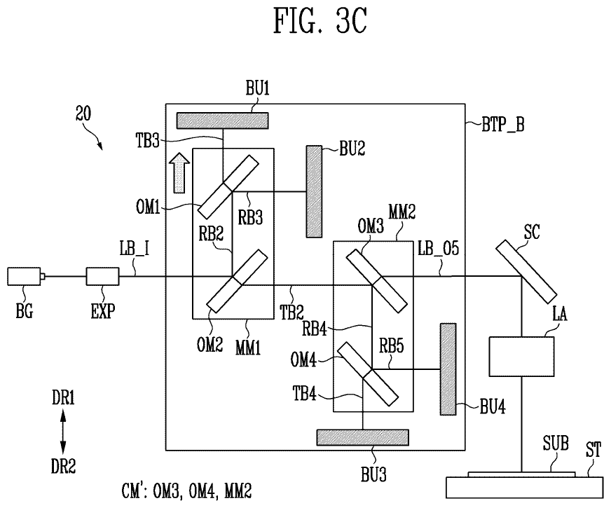

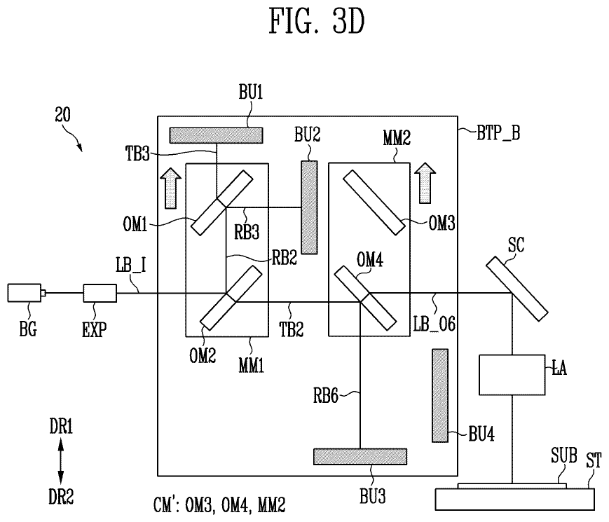

A laser processing apparatus 20 according to an embodiment will be described in detail with reference to FIGS. 3A to 3D.

FIG. 3A is a block diagram illustrating a first operating example of a laser processing apparatus according to an embodiment of the present disclosure. FIG. 3B is a block diagram illustrating a second operating example of the laser processing apparatus according to an embodiment of the present disclosure. FIG. 3C is a block diagram illustrating a third operating example of the laser processing apparatus according to an embodiment of the present disclosure. FIG. 3D is a block diagram illustrating a fourth operating example of the laser processing apparatus according to an embodiment of the present disclosure.

Compared with the laser processing apparatus 10 shown in FIGS. 1A and 1B, the laser processing apparatus 20 shown in FIGS. 3A to 3D may differ in that a compensation member CM′ includes a third optical member OM3, a fourth optical member OM4, and a second moving member MM2.

That is, a beam generator BG, a beam expander EXP, a light converter BTP_B including a first optical member OM1, a second optical member OM2 and a first moving member MM1, a scanner SC, and a lens array LA shown in FIGS. 3A to 3D may be similar to those, indicated by the same reference numerals, shown in FIGS. 1A and 1B. Therefore, duplicate descriptions thereof will be omitted.

Referring to FIGS. 3A to 3D, the compensation member CM′ may be arranged on a downstream side of the first moving member MM1 in an optical path to compensate for or adjust the path of incident light. For example, the compensation member CM may include the third optical member OM3, the fourth optical member OM4, and the second moving member MM2.

The third optical member OM3 may be arranged on a downstream side of the first optical member OM1 in the optical path to compensate for or adjust an optical path of the first transmitted light TB1 incident from the first optical member OM1. For example, the third optical member OM3 may correct the optical path of the first transmitted light TB1 to match an optical path of third output light LB_O3 with an optical path of incident light LB_I.

In addition, the third optical member OM3 may be a component having a third reflectivity different from the first and second reflectivity, and may be configured to reflect a portion of the first transmitted light TB1 or the second transmitted light TB2 corresponding to the third reflectivity and transmit the other portion of the first transmitted light TB1 or the second transmitted light TB2. For example, when the third reflectivity is 75%, the third optical member OM3 may reflect 75% of the first transmitted light TB1 or the second transmitted light TB2, and transmit the remaining 25%.

The third optical member OM3 may be any one of a beam splitter or a compensator. The third optical member OM3 and the first optical member OM1 may be symmetrical with respect to an imaginary line formed along the first direction DR1 or the second direction DR2. In other words, a direction in which light incident on the third optical member OM3 is reflected may be opposite to a direction in which light incident on the first optical member OM1 is reflected. For example, the first optical member OM1 shown in FIG. 3A may reflect the incident light LB_I toward the first direction DR1, while the third optical member OM3 may reflect the incident first transmitted light TB1 toward the second direction DR2. In this way, when the first optical member OM1 and the third optical member OM3 are arranged symmetrically to each other in the optical path, optical paths of the incident light LB_I incident on the first optical member OM1 and the third output light LB_O3 output from the third optical member OM3 may be substantially identically corrected.

The fourth optical member OM4 may be a component having a fourth reflectivity different from the first to third reflectivity, and may be configured to reflect a portion of the second reflected light RB2 corresponding to the fourth reflectivity and transmit the other portion of the second reflected light RB2. For example, when the fourth reflectivity is 70%, the fourth optical member OM4 may reflect 70% of the second reflected light RB2 and transmit the remaining 30%. Since the fourth optical member OM4 may have a similar configuration as the third optical member OM3, a detailed description thereof will be omitted for convenience of description.

The second moving member MM2 may move to support the third optical member OM3 and the fourth optical member OM4. The second moving member MM2 may operate in one of a third mode (see FIGS. 3A and 3C) in which the third optical member OM3 is arranged in the optical path of the first transmitted light TB1 or a second transmitted light TB2, or in a fourth mode (see FIGS. 3B and 3D) in which the fourth optical member OM4 is arranged in the optical path of the first transmitted light TB1 or the second transmitted light TB2.

FIGS. 3A and 3C show a state in which the third optical member OM3 is arranged in the optical path of the first transmitted light TB1 or the second transmitted light TB2. In addition, FIGS. 3B and 3D show a state in which the fourth optical member OM4 is arranged in the optical path of the first transmitted light TB1 or the second transmitted light TB2. In other words, FIGS. 3A and 3C show the second moving member MM2 in the third mode, and FIGS. 3B and 3D show the second moving member M2 in the fourth mode. As shown in FIGS. 3B and 3D, the second moving member MM2 may move in the first direction DR1 from the position of the second moving member MM2 shown in FIGS. 3A and 3C, respectively. Conversely, the second moving member MM2 may move in the second direction DR2 from the position shown in FIGS. 3B and 3D to the position shown in FIGS. 3A and 3C. That is, the second moving member MM2 may selectively place either the third optical member OM3 or the fourth optical member OM4, each having different reflectivity, in the optical path of the first transmitted light TB1 or the second transmitted light TB2.

In FIGS. 3A to 3D, the second moving member MM2 is shown as moving linearly along the first direction DR1 and the second direction DR2 like the first moving member MM1, but the embodiment of the present disclosure is not limited thereto. For example, the second moving member MM2 may rotate to support the third optical member OM3 and the fourth optical member OM4, like the first moving member MM1. Since the second moving member MM2 may operate in the same manner as the first moving member MM1, detailed descriptions thereof will be omitted for convenience of description.

Hereinafter, a detailed explanation is provided regarding the principle by which the first moving member MM1 and the second moving member MM2, by operating them in different modes, generate output lights having different outputs with reference to FIGS. 3A to 3D.

FIG. 3A shows a state in which the first moving member MM1 operates in the first mode and the second moving member MM2 operates in the third mode.

As described in FIG. 1A, the first optical member OM1 may reflect a portion of the incident light LB_I, corresponding to the first reflectivity, as the first reflected light RB1, and transmit the other portion of the incident light LB_I, excluding the first reflected light RB1, as the first transmitted light TB1, and the first absorbing member BU1 may absorb the first reflected light RB1.

Referring back to FIG. 3A, the third optical member OM3 may be arranged in the optical path of the first transmitted light TB1. The third optical member OM3 may reflect a portion of the first transmitted light TB1 corresponding to the third reflectivity as the second reflected light RB2, and transmit the other portion of the first transmitted light TB1 excluding the second reflected light RB2 as the third output light LB_O3.

The fourth optical member OM4 may be arranged on a downstream side of the third optical member OM3 in the optical path of the second reflected light RB2. That is, the second reflected light RB2 reflected by the third optical member OM3 may be incident on the fourth optical member OM4. The fourth optical member OM4 may reflect a portion of the second reflected light RB2 corresponding to the fourth reflectivity as the third reflected light RB3, and transmit the other portion of the second reflected light RB2 excluding the third reflected light RB3 as the second transmitted light TB2.

When the first moving member MM1 is in the first mode and the second moving member MM2 is in the third mode, the first absorbing member BU1 may absorb the first reflected light RB1, the third absorbing member BU3 may absorb the second transmitted light TB2, and the fourth absorbing member BU4 may absorb the third reflected light RB3. The first, third, and fourth absorbing members BU1, BU3, and BU4 may absorb the first and third reflected light RB1 and RB3 and the second transmitted light TB2, excluding the third output light LB_O3 used for processing the substrate SUB. This prevents the reflected light from irradiating other components inside the laser processing apparatus 20, thereby reducing the risk of equipment damage.

As shown in FIG. 3A, when the first moving member MM1 operates in the first mode and the second moving member MM2 operates in the third mode, a compensation member CM′ may be arranged on the downstream side of the first optical member OM1 in the optical path, and compensate for or adjust the optical path of the first transmitted light TB1 incident from the first optical member OM1. The compensation member CM′ may convert the first transmitted light TB1 into the third output light LB_O3 having a third output different from those of the first and second output lights LB_O1 and LB_O2.

FIG. 3B shows a state in which the first moving member MM1 operates in the first mode and the second moving member MM2 operates in the fourth mode.

As shown in FIG. 3B, the fourth optical member OM4 may be arranged in the optical path of the first transmitted light TB1. This may be implemented by the second moving member MM2 moving a predetermined distance in the first direction DR1 as described above. The fourth optical member OM4 may reflect a portion of the first transmitted light TB1 corresponding to the fourth reflectivity as fourth reflected light RB4, and transmit the other portion of the first transmitted light TB1 excluding the fourth reflected light RB4 as fourth output light LB_O4.

When the first moving member MM1 is in the first mode and the second moving member MM2 is in the fourth mode, the first absorbing member BU1 may absorb the first reflected light RB1, and the third absorbing member BU3 may absorb the fourth reflected light RB4. The first and third absorbing members BU1 and BU3 may absorb the first and fourth reflected light RB1 and RB4 except for the fourth output light LB_O4 used for processing the substrate SUB. This prevents the reflected light from irradiating other components inside the laser processing apparatus 20, thereby reducing the risk of equipment damage.

As shown in FIG. 3B, when the first moving member MM1 operates in the first mode and the second moving member MM2 operates in the fourth mode, the compensation member CM′ may be arranged on the downstream side of the first optical member OM1 in the optical path, and compensate for or adjust the optical path of the first transmitted light TB1 incident from the first optical member OM1. The compensation member CM′ may convert the first transmitted light TB1 into the fourth output light LB_O4 having a fourth output different from those of the first to third output lights LB_O1 to LB_O3.

FIG. 3C shows a state in which the first moving member MM1 operates in the second mode and the second moving member MM2 operates in the third mode.

As describe above with reference to FIG. 1B, the second optical member OM2 may reflect a portion of the incident light LB_I, corresponding to the second reflectivity, as the second reflected light RB2, and transmit the other portion of the incident light LB_I, excluding the second reflected light RB2, as the second transmitted light TB2. The first optical member OM1 may reflect a portion of the second reflected light RB2, corresponding to the second reflectivity, as the third reflected light RB3, and transmit the other portion of the second reflected light RB2, excluding the third reflected light RB3, as the third transmitted light TB3. The first absorbing member BU1 may absorb the third transmitted light TB3, and the second absorbing member BU2 may absorb the third reflected light RB3

Referring back to FIG. 3C, the third optical member OM3 may be arranged in the optical path of the second transmitted light TB2. The third optical member OM3 may reflect a portion of the second transmitted light TB2 corresponding to the third reflectivity as the fourth reflected light RB4, and transmit the other portion of the second transmitted light TB2 excluding the fourth reflected light RB4 as fifth output light LB_O5.

The fourth optical member OM4 may be arranged on a downstream side of the third optical member OM3 in the optical path of the fourth reflected light RB4. That is, the fourth reflected light RB4 reflected by the third optical member OM3 may be incident on the fourth optical member OM4. The fourth optical member OM4 may reflect a portion of the fourth reflected light RB4 corresponding to the fourth reflectivity as fifth reflected light RB5, and transmit the other portion of the fourth reflected light RB4 excluding the fifth reflected light RB5 as fourth transmitted light TB4.

When the first moving member MM1 is in the second mode and the second moving member MM2 is in the third mode, the first absorbing member BU1 may absorb the third transmitted light TB3, the second absorbing member BU2 may absorb the third reflected light RB3, the third absorbing member BU3 may absorb the fourth transmitted light TB4, and the fourth absorbing member BU4 may absorb the fifth reflected light RB5. The first to fourth absorbing members BU1 to BU4 may absorb the third and fourth transmitted lights TB3 and TB4, the third reflected light RB3, and the fifth reflected light RB5, excluding the fifth output light LB_O5 used for processing the substrate SUB. This prevents the reflected light from irradiating other components inside the laser processing apparatus 20, thereby reducing the risk of equipment damage.

As shown in FIG. 3C, when the first moving member MM1 operates in the second mode and the second moving member MM2 operates in the third mode, the compensation member CM′ may be arranged on the downstream side of the second optical member OM2 in the optical path, and compensate for or adjust the optical path of the second transmitted light TB2 incident from the second optical member OM2. The compensation member CM′ may convert the second transmitted light TB2 into the fifth output light LB_O5 having a fifth output different from those of the first to fourth output lights LB_O1 to LB_O4.

FIG. 3D shows a state in which the first moving member MM1 operates in the second mode and the second moving member MM2 operates in the fourth mode.

Referring to FIG. 3D, the fourth optical member OM4 may be arranged in the optical path of the second transmitted light TB2. This may be implemented by the second moving member MM2 moving a predetermined distance in the first direction DR1 as described above. The fourth optical member OM4 may reflect a portion of the second transmitted light TB2 corresponding to the fourth reflectivity as sixth reflected light RB6, and transmit the other portion of the second transmitted light TB2 excluding the sixth reflected light RB6 as sixth output light LB_O6.

When the first moving member MM1 is in the second mode and the second moving member MM2 is in the fourth mode, the first absorbing member BU1 may absorb the third transmitted light TB3, the second absorbing member BU2 may absorb the third reflected light RB3, and the third absorbing member BU3 may absorb the sixth reflected light RB6. The first to third absorbing members BU1 to BU3 may absorb the third transmitted light TB3, the third reflected light RB3, and the sixth reflected light RB6, excluding the sixth output light LB_O6 used for processing the substrate SUB. This prevents the reflected light from irradiating other components inside the laser processing apparatus 20, thereby reducing the risk of equipment damage.

As shown in FIG. 3D, when the first moving member MM1 is in the second mode and the second moving member MM2 is in the fourth mode, the compensation member CM′ may be arranged on the downstream side of the second optical member OM2 in the optical path, and compensate for or adjust the optical path of the second transmitted light TB2 incident from the second optical member OM2. The compensation member CM′ may convert the second transmitted light TB2 into the sixth output light LB_O6 having a sixth output different from those of the first to fifth output lights LB_O1 to LB_O5.

The laser processing apparatus 20 shown in FIGS. 3A to 3D may constitute a single optical system. According to this structure, the laser processing apparatus 20 may generate the third to sixth output lights LB_O3 to LB_O6 having four different outputs, and may select one output light, among the third to sixth output lights LB_O3 to LB_O6, which has an output suitable for processing and irradiate the selected output light onto the processing object.

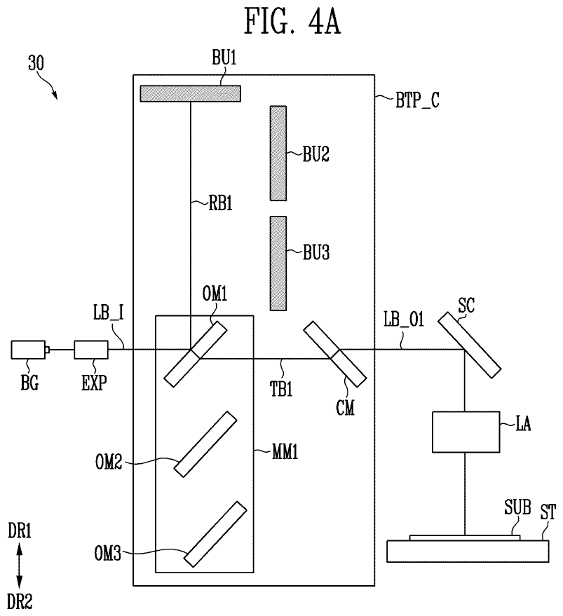

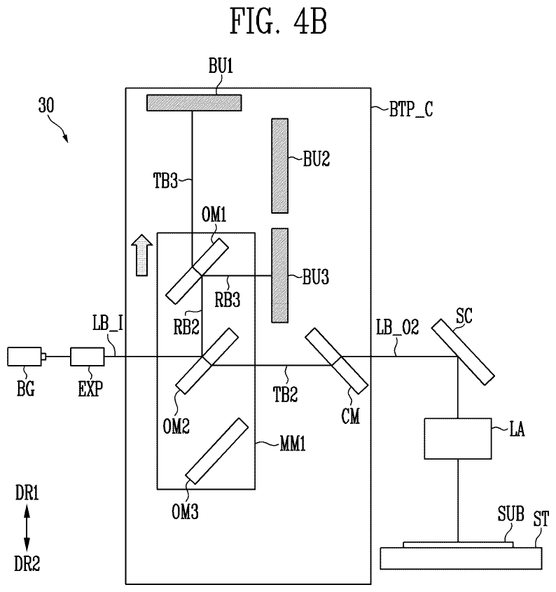

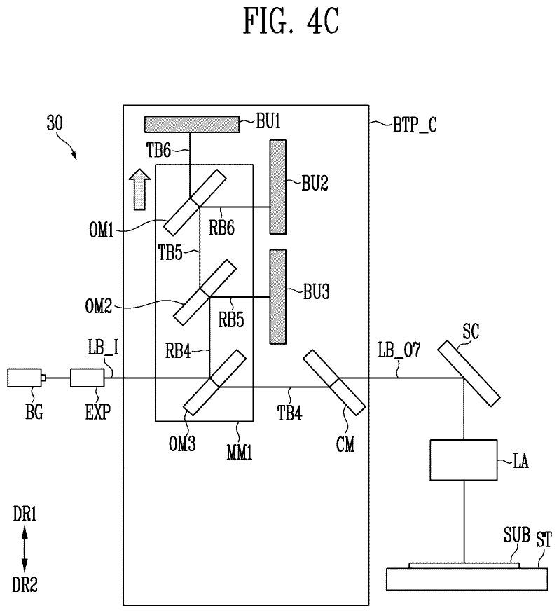

A laser processing apparatus 30 according to an embodiment of the present disclosure will be described in detail with reference to FIGS. 4A to 4C.

FIG. 4A is a block diagram illustrating a first operating example of a laser processing apparatus according to an embodiment of the present disclosure. FIG. 4B is a block diagram illustrating a second operating example of the laser processing apparatus according to an embodiment of the present disclosure. FIG. 4C is a block diagram illustrating a third operating example of the laser processing apparatus according to an embodiment of the present disclosure.

Compared with the laser processing apparatus 10 shown in FIGS. 1A and 1B, the laser processing apparatus 30 shown in FIGS. 4A to 4C may differ in that a third optical member OM3 is included in a first moving member MM1.

That is, a beam generator BG, a beam expander EXP, a light converter BTP_C including a first optical member OM1, a second optical member OM2 and a first moving member MM1, a scanner SC, and a lens array LA shown in FIGS. 4A to 4C may be similar to those, indicated by the same reference numerals, shown in FIGS. 1A and 1B. Therefore, duplicate descriptions thereof will be omitted.

The first moving member MM1 shown in FIGS. 4A to 4C may have a similar configuration as to the first moving member MM1 shown in FIGS. 1A and 1B, except that the first moving member MM1 further includes the third optical member OM3. Therefore, a redundant description thereof will be omitted below.

FIG. 4A shows a state in which the first moving member MM1 operates in the first mode.

Referring to FIG. 4A, the first optical member OM1 may be arranged in an optical path of incident light LB_I. The first optical member OM1 may reflect a portion of the incident light LB_I corresponding to a first reflectivity as first reflected light RB1, and transmit the other portion of the incident light LB_I excluding the first reflected light RB1 as first transmitted light TB1.

The first absorbing member BU1 may absorb the first reflected light RB1 reflected by the first optical member OM1. In this way, when the first moving member MM1 is in the first mode, the first absorbing member BU1 may absorb the first reflected light RB1, excluding first output light LB_O1 used for processing the substrate SUB, thereby preventing the risk of the equipment being damaged due to the reflected light.

A compensation member CM may be arranged on a downstream side of the first optical member OM1 in the optical path, and compensate for or adjust an optical path of the first transmitted light TB1 incident from the first optical member OM1. The compensation member CM may convert the first transmitted light TB1 into the first output light LB_O1 having a first output.

FIG. 4B shows a state in which the first moving member MM1 operates in the second mode.

Referring to FIG. 4B, the second optical member OM2 may be arranged in the optical path of the incident light LB_I. This may be implemented by the first moving member MM1 moving a predetermined distance in the first direction DR1 as described above. The second optical member OM2 may reflect a portion of the incident light LB_I corresponding to a second reflectivity as second reflected light RB2, and transmit the other portion of the incident light LB_I excluding the second reflected light RB2 as second transmitted light TB2.

The first optical member OM1 may be arranged on a downstream side of the second optical member OM2 in the optical path of the second reflected light RB2. That is, the second reflected light RB2 reflected from the second optical member OM2 may be incident onto the first optical member OM1. The first optical member OM1 may reflect a portion of the second reflected light RB2 corresponding to the first reflectivity as third reflected light RB3, and transmit the other portion of the second reflected light RB2 excluding the third reflected light RB3 as third transmitted light TB3.

When the first moving member MM1 is in the second mode, the first absorbing member BU1 may absorb the third transmitted light TB3, and the third absorbing member BU3 may absorb the third reflected light RB3. The first and third absorbing members BU1 and BU3 may absorb the reflected light, excluding the light used for processing the substrate SUB, thereby preventing the risk of the equipment being damaged due to the reflected light.

The compensation member CM may be arranged on the downstream side of the second optical member OM2 in the optical path, and compensate for or adjust the optical path of the second transmitted light TB2 incident from the second optical member OM2. In this case, the compensation member CM may convert the second transmitted light TB2 into second output light LB_O2 having a second output.

FIG. 4C shows a state in which the first moving member MM1 operates in the third mode.

Referring to FIG. 4C, the third optical member OM3 may be arranged in the optical path of the incident light LB_I. This may be implemented by moving the first moving member MM1 moving a predetermined distance further in the first direction DR1 compared to FIG. 4B. The third optical member OM3 may reflect a portion of the incident light LB_I corresponding to a third reflectivity as fourth reflected light RB4, and transmit the other portion of the incident light LB_I excluding the fourth reflected light RB4 as fourth transmitted light TB4.

The second optical member OM2 may be arranged on a downstream side of the third optical member OM3 in the optical path of the fourth reflected light RB4. That is, the fourth reflected light RB4 reflected from the third optical member OM3 may be incident onto the second optical member OM2. The second optical member OM2 may reflect a portion of the fourth reflected light RB4 corresponding to the second reflectivity as fifth reflected light RB5, and transmit the other portion of the fourth reflected light RB4 excluding the fifth reflected light RB5 as fifth transmitted light TB5.

The first optical member OM1 may be arranged on the downstream side of the second optical member OM2 in the optical path of the fifth transmitted light TB5. That is, the fifth transmitted light TB5 transmitted through the second optical member OM2 may be incident onto the first optical member OM1. The first optical member OM1 may reflect a portion of the fifth transmitted light TB5 corresponding to the first reflectivity as sixth reflected light RB6, and transmit the other portion of the fifth transmitted light TB5 excluding the sixth reflected light RB6 as sixth transmitted light TB6.

When the first moving member MM1 is in the third mode, the first absorbing member BU1 may absorb the sixth transmitted light TB6, the second absorbing member BU2 may absorb the sixth reflected light RB6, and the third absorbing member BU3 may absorb the fifth reflected light RB5. The first to third absorbing members BU1 to BU3 may absorb the reflected light, excluding the light used for processing the substrate SUB, thereby preventing the risk of the equipment being damaged by the reflected light.

A compensation member CP may be arranged on the downstream side of the third optical member OM3 in the optical path, and compensate for or adjust an optical path of the fourth transmitted light TB4 incident from the third optical member OM3. The compensation member CM may convert the fourth transmitted light TB4 into seventh output light LB_O7 having a seventh output.

The laser processing apparatus 30 shown in FIGS. 4A to 4C may constitute a single optical system. According to this structure, the laser processing apparatus 30 may generate the first, second, and seventh output lights LB_O1, LB_O2, and LB_O7 having three different outputs, and may select one output light, among the first, second, and seventh output lights LB_O1, LB_O2, and LB_O7, which has an output suitable for processing and irradiate the selected output light onto the processing object.

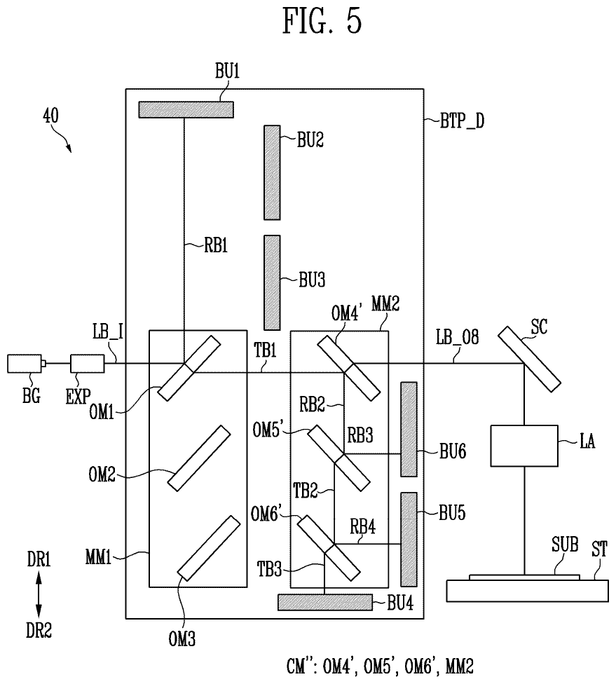

A laser processing apparatus 40 according to an embodiment of the present disclosure will be schematically described with reference to FIG. 5.

FIG. 5 is a block diagram illustrating an operating example of a laser processing apparatus according to an embodiment of the present disclosure.

Compared with the laser processing apparatus 30 shown in FIGS. 4A to 4C, the laser processing apparatus 40 shown in FIG. 5 may differ in that a compensation member CM″ may include a fourth optical member OM4′, a fifth optical member OM5′, a sixth optical member OM6′, and a second moving member MM2, and may further include fourth to sixth absorbing members BU4 to BU6 for absorbing third transmitted light TB3 and third and fourth reflected lights RB3 and RB4, excluding eighth output light LB_O8 output from the compensation member CM″.

That is, a beam generator BG, a beam expander EXP, a light converter BTP_D including first to third optical members OM1 to OM3, a first moving member MM1 and first to third absorbing members BU1 to BU3, a scanner SC, and a lens array LA shown in FIG. 5 may be similar to those, indicated by the same reference numerals, shown in FIGS. 4A to 4C. Therefore, duplicate descriptions thereof will be omitted.

Referring to FIG. 5, the compensation member CM″ may be arranged on a downstream side of the first optical member OM1 in an optical path of the first transmitted light TB1 and compensate for or adjust the path of incident light. For example, the compensation member CM″ may include the fourth optical member OM4′, the fifth optical member OM5′, the sixth optical member OM6′, and the second moving member MM2.

Here, fourth to sixth optical members OM4′ to OM6′ of the compensation member CM″ may have a similar configuration as the third optical member OM3 or the fourth optical member OM4 described with reference to FIGS. 3A to 3D. For example, except that the fourth optical member OM4 may have a fourth reflectivity different from the first to third reflectivity, the fifth optical member OM5 may have a fifth reflectivity different from the first to fourth reflectivity, and the sixth optical member OM6 may have a sixth reflectivity different from the first to fifth reflectivity, the remaining features of the fourth to sixth optical members OM4′ to OM6′ may be the same as the features of either the third optical member OM3 or the fourth optical member OM4 described with reference to FIGS. 3A to 3D. Therefore, detailed descriptions thereof will be omitted below.

In addition, for convenience of description, FIG. 5 shows only a state in which the fourth optical member OM4 is arranged in an optical path of the first transmitted light TB1, but an embodiment of the present disclosure is not necessarily limited thereto. Although not shown in the drawings, the second optical member OM2 or the third optical member OM3 may be arranged in an optical path of incident light LB_I. In addition, the fifth optical member OM5′ or the sixth optical member OM6′ may be arranged in an optical path of any one of first, second, and fourth transmitted lights TB1, TB2, and TB4.

In other words, depending on the operation modes of the first moving member MM1 and the second moving member MM2, any one of the first to third optical members OM1 to OM3 may be arranged in the optical path of the incident light LB_I, and any one of the fourth to sixth optical members OM4 to OM6 may be arranged in the path of light incident on the second moving member MM2.

The laser processing apparatus 40 shown in FIG. 5 may constitute a single optical system. According to this structure, the laser processing apparatus 40 may generate output lights (not shown) having nine different outputs, and may select one of them having an output suitable for processing and irradiate the selected output light onto the processing object.

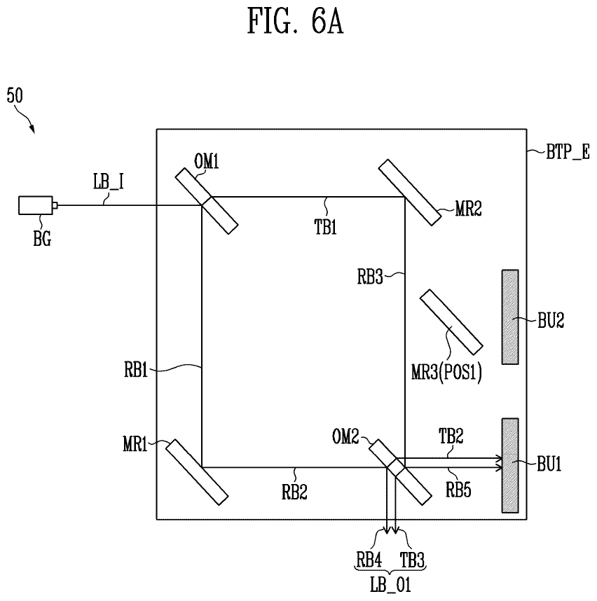

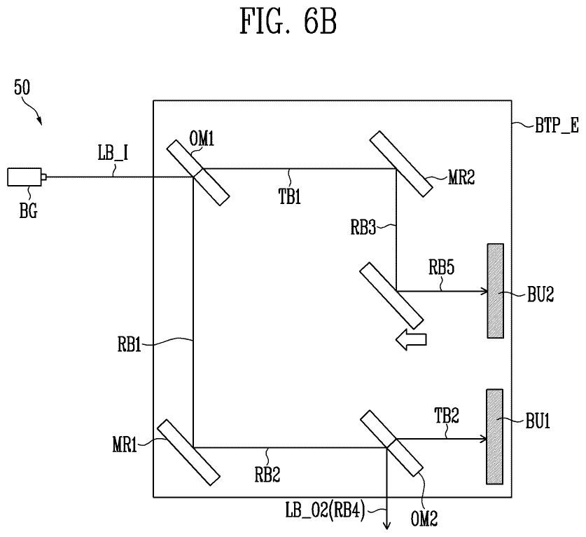

A laser processing apparatus 50 according to an embodiment of the present disclosure will be described in detail with reference to FIGS. 6A and 6B.

FIG. 6A is a block diagram illustrating a first operating example of a laser processing apparatus according to an embodiment of the present disclosure. FIG. 6B is a block diagram illustrating a second operating example of the laser processing apparatus according to an embodiment of the present disclosure.

Referring to FIGS. 6A and 6B together, the laser processing apparatus 50 may include a beam generator BG and a light converter BTP_E. Although not shown in the drawings, the laser processing apparatus 50 may further include the beam expander EXP, the scanner SC, and the lens array LA described with reference to FIGS. 1A and 1B. For example, the beam expander EXP may be disposed between the beam generator BG and the light converter BTP_E. In addition, the scanner SC and the lens array LA may be disposed on a downstream side of the light converter BTP_E in an optical path.

The beam generator BG may generate incident light LB_I and output the incident light LB_I toward the light converter BTP_E.

The light converter BTP_E may be arranged in an optical path of the incident light LB_I to convert the incident light LB_I into one of first output light LB_O1 having a first output and second output light LB_O2 having a second output different from the first output. FIG. 6A shows that the light converter BTP_E outputs the first output light LB_O1, and FIG. 6B shows that the light converter BTP_E outputs the second output light LB_O2.

The light converter BTP_E may include a first optical member OM1, a first mirror MR1, a second mirror MR2, a second optical member OM2, a third mirror MR3, a first absorbing member BU1, and a second absorbing member BU2.

The first optical member OM1 may be arranged on a downstream side in the optical path of the incident light LB_I. The first optical member OM1 may have a first reflectivity, and may be configured to reflect a portion of the incident light LB_I corresponding to the first reflectivity as first reflected light RB1 and transmit the other portion of the incident light LB_I excluding the first reflected light RB1 as first transmitted light TB1. For example, when the first reflectivity is 5%, the first optical member OM1 may reflect 5% of the incident light LB_I and transmit the remaining 95%. That is, when an output of the incident light LB_I is defined as 100 W, an output of the first reflected light RB1 may be 5 W, and an output of the first transmitted light TB1 may be 95 W.

The first optical member OM1 may be a beam splitter, but the embodiment of the present disclosure is not limited thereto. For example, the first optical member OM1 may be an optical component suitable for reflecting a portion of the incident light LB_I and transmitting the other portion of the incident light LB_I.

The first mirror MR1 may totally reflect the first reflected light RB1 and output second reflected light RB2. The second reflected light RB2 may be irradiated onto a first surface of the second optical member OM2, which will be described later. Since the output of the first reflected light RB1 is 5 W, an output of the second reflected light RB2 may also be 5 W.

The second mirror MR2 may totally reflect the first transmitted light TB1 and output third reflected light RB3. The third reflected light RB3 may be irradiated onto a second surface of the second optical member OM2, which will be described later. Since the output of the first transmitted light TB1 is 95 W, an output of the third reflected light RB3 may also be 95 W.

The second optical member OM2 may have a second reflectivity different from the first reflectivity, and may be arranged on a downstream side of the first mirror MR1 and the second mirror MR2 in the optical path.

The third mirror MR3 may be configured to be movable between a first position POS1 (shown in FIG. 6A) that does not overlap with the optical paths of the second reflected light RB2 and the third reflected light RB3, and a second position POS2 (shown in FIG. 6B) that overlaps with the optical path of either the second reflected light RB2 or the third reflected light RB3. For convenience of description, FIGS. 6A and 6B show a case where the third mirror MR3 can be moved between the first position POS1 that does not overlap with an optical path of the third reflected light RB3 and the second position POS2 that overlaps with the optical path of the third reflected light RB3, but the present disclosure is not limited thereto. For example, the third mirror MR3 may be configured to be movable between a third position (not shown) that does not overlap with the optical path of the second reflected light RB2 and a fourth position (not shown) that overlaps with the optical path of the second reflected light RB2.

FIG. 6A shows that the third mirror MR3 does not overlap with the optical path of the third reflected light RB3. That is, FIG. 6A shows a case where the third mirror MR3 is disposed at the first position POS1. In this case, the third reflected light RB3 output from the second mirror MR2 may be irradiated onto the second surface of the second optical member OM2 without interference with an optical path by the third mirror MR3.

The second optical member OM2 may reflect a portion of the second reflected light RB2 incident on the first surface thereof corresponding to the second reflectivity as fourth reflected light RB4, and transmit the other portion of the second reflected light RB2 as second transmitted light TB2. For example, when the second reflectivity is 10%, the second optical member OM2 may reflect the fourth reflected light RB4, which amounts to 10% of the second reflected light RB2, and transmit the second transmitted light TB2, which amounts to 90% of the second reflected light RB2. That is, since the output of the second reflected light RB2 is 5 W, an output of the fourth reflected light RB4 may be 0.5 W, and an output of the second transmitted light TB2 may be 4.5 W.

In addition, the second optical member OM2 may reflect a portion of the third reflected light RB3 incident on the second surface thereof corresponding to the second reflectivity as fifth reflected light RB5 and transmit the other portion of the third reflected light RB3 excluding the fifth reflected light RB5 as third transmitted light TB3. As described above, when the second reflectivity is 10%, the second optical member OM2 may reflect the fifth reflected light RB5, which amounts to 10% of the third reflected light RB3, and transmit the third transmitted light TB3, which amounts to 90% of the third reflected light RB3. That is, since the output of the third reflected light RB3 is 95 W, an output of the fifth reflected light RB5 may be 9.5 W, and an output of the third transmitted light TB3 may be 85.5 W.

The second optical member OM2 may collect the fourth reflected light RB4 and the third transmitted light TB3 to output the first output light LB_O1. Although not shown in the drawings, the first output light LB_O1 may pass through the scanner and the lens array and be irradiated onto the first functional layer of the substrate disposed on the stage. Here, since the first output light LB_O1 has an output of 86 W by collecting the fourth reflected light RB4 having an output of 0.5 W and the third transmitted light TB3 having the output of 85.5 W, the first output light LB_O1 may be attenuated by 86% compared to the incident light LB_I having the output of 100 W.

The second optical member OM2 may be a beam splitter, like the first optical member OM1, but the embodiment of the present disclosure is not limited thereto. The second optical member OM2 may include an optical component suitable for reflecting a portion of each of the second reflected light RB2 and the third reflected light RB3 and transmitting the other portion of each of the second reflected light RB2 and the third reflected light RB3, like the first optical member OM1.

The first absorbing member BU1 may absorb the second transmitted light TB2 and the fifth reflected light RB5. The first absorbing member BU1 may absorb reflected light and transmitted light except for output light used for processing the substrate. The first absorbing member BU1 may include a material capable of absorbing light, for example, a conductive material or an insulating material. As a conductive material forming the first absorbing member BU1, chromium (Cr), molybdenum (Mo), nickel (Ni), titanium (Ti), cobalt (Co), copper (Cu), or aluminum (AI), an alloy material containing the above-mentioned elements as a main component, a compound (for example, a nitrogen compound, an oxygen compound, a carbon compound, a halogen compound, or the like), or the like may be used, but the present disclosure is not limited thereto.

The second absorbing member BU2 may be a component for absorbing light which is reflected by the third mirror MR3 when the third mirror MR3 is disposed at the second position POS2 (shown in FIG. 6B) overlapping the optical path of the third reflected light RB3, and will be described below with reference to FIG. 6B.

Referring to FIG. 6B, the third mirror MR3 may be moved to the second position POS2, which is a downstream side of the second mirror MR2 in the optical path of the third reflected light RB3. When the third mirror MR3 is disposed at the second position POS2, the second reflected light RB2 may be irradiated onto a first surface of the second optical member OM2, and the third reflected light RB3 may be totally reflected by the third mirror MR3 and not be output to the second optical member OM2. In this case, the third mirror MR3 may totally reflect the third reflected light RB3 and output the fifth reflected light RB5.

In this case, the second optical member OM2 may reflect a portion of the second reflected light RB2 incident on the first surface thereof corresponding to the second reflectivity as the fourth reflected light RB4, and transmit the other portion of the second reflected light RB2 excluding the fourth reflected light RB4 as the second transmitted light TB2.

The second optical member OM2 may output the fourth reflected light RB4 as the second output light LB_O2. Although not shown in the drawings, the second output light LB_O2 may pass through the scanner and the lens array and be irradiated onto the second functional layer of the substrate disposed on the stage. Here, the second functional layer may be a different layer different from the first functional layer to which the first output light LB_O1 described with reference to FIG. 6A is irradiated, and may or may not be the same as the first functional layer FL1 or the second functional layer FL2 described with reference to FIGS. 2A to 2C.

As described above, since the fourth reflected light RB4 may have an output of 0.5, an output of the second output light LB_O2 may be 0.5. This means that a ratio of the first output light LB_O1, when the third mirror MR3 is disposed at the first position POS1, and the second output light LB_O2, when the third mirror MR3 is disposed at the second position POS2, may be 86:0.5, so the second output light LB_O2 can be attenuated by 172:1 compared to the first output light LB_O1. That is, depending on the position the third mirror MR3, output lights having different outputs may be generated.

The laser processing apparatus 50 shown in FIGS. 6A and 6B may constitute a single optical system. According to this structure, the laser processing apparatus 50 may generate the first output light LB_O1 and the second output light LB_O2 having two different outputs, and may selectively irradiate either the first output light LB_O1 or the second output light LB_O2 onto the processing object.

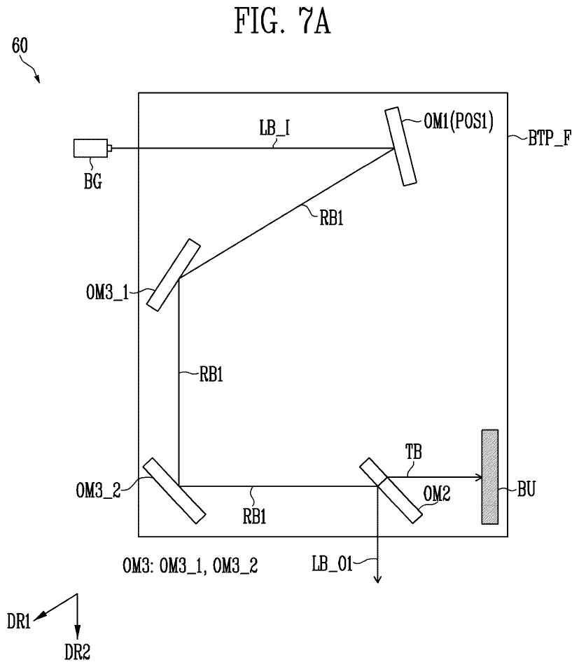

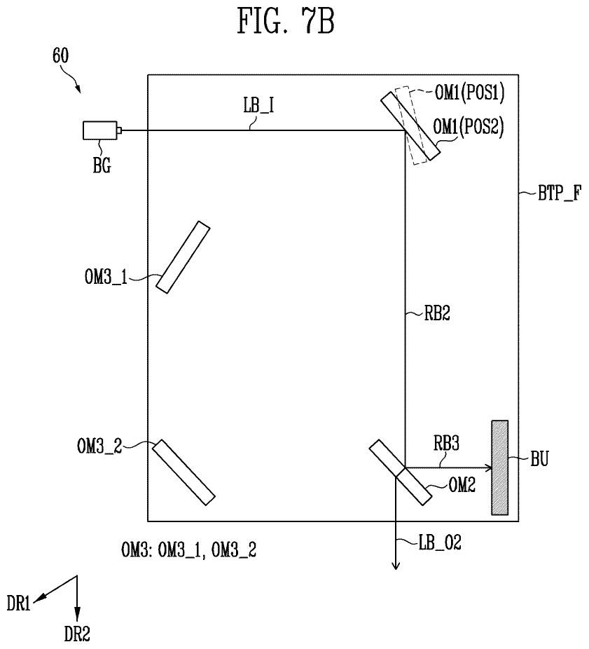

A laser processing apparatus 60 according to an embodiment of the present disclosure will be described in detail with reference to FIGS. 7A and 7B.

FIG. 7A is a block diagram illustrating a first operating example of a laser processing apparatus according to an embodiment of the present disclosure. FIG. 7B is a block diagram illustrating a second operating example of the laser processing apparatus according to an embodiment of the present disclosure.

Referring to FIGS. 7A and 7B together, the laser processing apparatus 60 may include a beam generator BG and a light converter BTP_F. Although not shown in the drawings, the laser processing apparatus 60 may further include the beam expander EXP, the scanner SC, and the lens array LA described with reference to FIGS. 1A and 1B. For example, the beam expander EXP may be disposed between the beam generator BG and the light converter BTP_F. In addition, the scanner SC and the lens array LA may be arranged on a downstream side of the light converter BTP_F in an optical path.

The beam generator BG may generate incident light LB_I and output the incident light LB_I toward the light converter BTP_F.

The light converter BTP_F may be arranged in an optical path of the incident light LB_I and convert the incident light LB_I into one of first output light LB_O1 (shown in FIG. 7A) having a first output and second output light LB_O2 (shown in FIG. 7B) having a second output different from the first output. FIG. 7A shows that the light converter BTP_F outputs the first output light LB_O1, and FIG. 7B shows that the light converter BTP_F outputs the second output light LB_O2.

The light converter BTP_F may include a first optical member OM1, a second optical member OM2, a third optical member OM3, and an absorbing member BU.

The first optical member OM1 may be arranged on a downstream side of the beam generator BG in the optical path of the incident light LB_I and may be movable between a first posture POS1 (shown in FIG. 7A) for converting the incident light LB_I into first reflected light RB1 directed in the first direction DR1, and a second posture POS2 for converting the incident light LB_I into second reflected light RB2 (shown in FIG. 7B) directed in the second direction DR2 different from the first direction DR1.

The second optical member OM2 may have a predetermined reflectivity and may be disposed to overlap the first optical member OM1 in the second direction DR2.

The third optical member OM3 may be disposed between the first optical member OM1 and the second optical member OM2 in the optical path of the first reflected light RB1, and may totally reflect the first reflected light RB1 toward the second optical member OM2 when the first optical member OM1 is in the first posture POS1.

The third optical member OM3 may include a (3_1)th sub-optical member OM3_1 relatively adjacent to the first optical member OM1 and a (3_2)th sub-optical member OM3_2 relatively adjacent to the second optical member OM2. In this case, the (3_1)th sub-optical member OM3_1 may be arranged on a upstream side of the (3_2)th sub-optical member OM3_2 in the optical path.

However, an embodiment of the present disclosure is not limited thereto, and the number of a (3_n)th sub-optical member OM3_n may be selected in variously ways considering the arrangement structure of the first optical member OM1 and the second optical member OM2, where n may be a natural number. For example, when the first reflected light RB1 reflected from the first optical member OM1 does not directly proceed toward the second optical member OM2, the third optical member OM3 may include a predetermined number of (3_n)th sub-optical members OM3_n that may adjust the optical path to make the first reflected light RB1 directed toward the second optical member OM2.

In this case, the (3_n)th sub-optical members OM3_n may be sequentially disposed between the first optical member OM1 and the second optical ember OM2. For example, one (3_n)th sub-optical member OM3_n or three or more (3_n)th sub-optical members OM3_n may be disposed between the first optical member OM1 and the second optical member OM2. Hereinafter, for convenience of description, the description will focus on a case where the third optical member OM3 includes two (3_n)th sub-optical members OM3_n, that is, a case where the third optical member OM3 includes a (3_1)th sub-optical member OM3_1 and a (3_2)th sub-optical member OM3_2.

When the first optical member OM1 is in the first posture POS1, the (3_1) sub-optical member OM3_1 may totally reflect the first reflected light RB1 toward the (3_2) sub-optical member OM3_2.

When the first optical member OM1 is in the first posture POS1, the (3_2)th sub-optical member OM3_2 may totally reflect the first reflected light RB1, which is reflected from the (3_1)th sub-optical member OM3_1, toward the second optical member OM2.

When the first optical member OM1 is in the first posture POS1, the second optical member OM2 may reflect a portion of the first reflected light RB1, which is output from the third optical member OM3, corresponding to the reflectivity as the first output light LB_O1, and transmit the other portion of the first reflected light RB1 excluding the first output light LB_O1 as transmitted light TB.

In addition, when the first optical member OM1 is in the second posture POS2, the second optical member OM2 may reflect a portion of the second reflected light RB2, which is output from the first optical member OM1, corresponding to the reflectivity as third reflected light RB3, and transmit the other portion of the second reflected light RB2 excluding the third reflected light RB3 as the second output light LB_O2.

The absorbing member BU may absorb the transmitted light TB when the first optical member OM1 is in the first posture POS1, and may absorb the third reflected light RB3 when the first optical member OM1 is in the second posture POS2.

According to the laser processing apparatus 60 having the above-described structure, the first output light LB_O1 having a first output and the second output light LB_O2 having a second output different from the first output may be generated. For example, when an output of the incident light LB_I is 100 W and a reflectivity of the second optical member OM2 is 5%, an output of the first output light LB_O1 may be 5 W, and an output of the second output light LB_2 may be 95 W. As described above, the laser processing apparatus 60 shown in FIGS. 7A and 7B may generate two output lights having different outputs by adjusting the posture of the first optical member OM1.

The laser processing apparatus 60 shown in FIGS. 7A and 7B may constitute a single optical system. According to this structure, the laser processing apparatus 60 may generate the first output light LB_O1 and the second output light LB_O2 having two different outputs, and may selectively irradiate either the first output light LB_O1 or the second output light LB_O2 onto the processing object.

A laser processing apparatus according to an embodiment of the present disclosure may provide a single optical system that processes different workpieces. For example, the laser processing apparatus according to the embodiment of the present disclosure may constitute a single optical system that generates a plurality of output lights having different outputs, and may select one of the plurality of output lights having an output suitable for processing and irradiate the selected output light onto the processing object.

The effects of the present disclosure are not limited to the above-described effects, and may be variously extended without departing from the spirit and scope of the present disclosure.

Although specific terms are employed to explain an embodiment of the present disclosure, it will be understood that they are used, or should be interpreted, in a generic and descriptive sense only and not for the purpose of limitation. As would be apparent to one of ordinary skill in the art as of the filing of the present application, features, characteristics, or elements described in connection with a particular example of an embodiment of the present disclosure may be used singly or in combination with features, characteristics, or elements described in connection with other examples of the embodiment of the present disclosure unless otherwise specifically indicated. Accordingly, it will be understood by those of skill in the art that various changes in form and details may be made without departing from the spirit and scope of the present disclosure as set forth in the following claims.

What is claimed is:

1. A laser processing apparatus comprising:
a beam generator generating incident light; and
a light converter arranged in an optical path of the incident light and converting the incident light into a plurality of output lights having different outputs,
wherein the light converter includes:
a first optical member having a first reflectivity;
a second optical member having a second reflectivity different from the first reflectivity; and
a first moving member supporting the first optical member and the second optical member,
wherein the first moving member operates in a first mode in which the first optical member is arranged in the optical path of the incident light and operates in a second mode in which the second optical member is arranged in the optical path of the incident light.

2. The laser processing apparatus of claim 1, further comprising:
a beam expander disposed between the beam generator and the light converter.

3. The laser processing apparatus of claim 1,
wherein, when the first moving member operates in the first mode, the first optical member reflects a portion of the incident light corresponding to the first reflectivity as first reflected light, and transmits a remaining portion of the incident light excluding the first reflected light as first transmitted light, and
wherein the light converter further includes a first absorbing member absorbing the first reflected light.

4. The laser processing apparatus of claim 3,
wherein the light converter further includes a compensation member arranged on a downstream side of the first optical member and adjusting an optical path of the first transmitted light incident from the first optical member, and
wherein the compensation member converts the first transmitted light into a first output light having a first output.

5. The laser processing apparatus of claim 4,
wherein the compensation member includes:
a third optical member having a third reflectivity;
a fourth optical member having a fourth reflectivity different from the third reflectivity; and
a second moving member supporting the third optical member and the fourth optical member, and
wherein the second moving member operates in a third mode in which the third optical member is arranged in the optical path of the first transmitted light and operates in a fourth mode in which the fourth optical member is arranged in the optical path of the first transmitted light.

6. The laser processing apparatus of claim 5,
wherein, when the second moving member operates in the third mode, the third optical member reflects a portion of the first transmitted light corresponding to the third reflectivity as second reflected light, and transmits a remaining portion of the first transmitted light excluding the second reflected light as a second output light having a second output, and the fourth optical member reflects a portion of the second reflected light corresponding to the fourth reflectivity as third reflected light, and transmits a remaining portion of the second reflected light excluding the third reflected light as second transmitted light, and
wherein the light converter further includes a second absorbing member absorbing the second transmitted light and a third absorbing member absorbing the third reflected light.

7. The laser processing apparatus of claim 5,
wherein, when the second moving member operates in the fourth mode, the fourth optical member reflects a portion of the first transmitted light corresponding to the fourth reflectivity as fourth reflected light, and transmits a remaining portion of the first transmitted light excluding the fourth reflected light as a third output light having a third output.

8. The laser processing apparatus of claim 7, wherein the light converter further includes a second absorbing member absorbing the fourth reflected light.

9. The laser processing apparatus of claim 1,
wherein, when the first moving member operates in the second mode, the second optical member reflects a portion of the incident light corresponding to the second reflectivity as second reflected light, and transmits a remaining portion of the incident light excluding the second reflected light as second transmitted light, and the first optical member reflects a portion of the second reflected light corresponding to the first reflectivity as third reflected light, and transmits a remaining portion of the second reflected light excluding the third reflected light as third transmitted light, and
wherein the light converter further includes a first absorbing member absorbing the third transmitted light and a second absorbing member absorbing the third reflected light.

10. The laser processing apparatus of claim 9, wherein the light converter further includes a compensation member arranged on a downstream side of the second optical member and adjusting an optical path of the second transmitted light incident from the second optical member, and
wherein the compensation member converts the second transmitted light into a fourth output light having a fourth output.

11. The laser processing apparatus of claim 10,
wherein the compensation member includes:
a third optical member having a third reflectivity;
a fourth optical member having a fourth reflectivity different from the third reflectivity; and
a second moving member supporting the third optical member and the fourth optical member, and
wherein the second moving member operates in a fifth mode in which the third optical member is arranged in the optical path of the second transmitted light and operates in a sixth mode in which the fourth optical member is arranged in the optical path of the second transmitted light.

12. The laser processing apparatus of claim 11,
wherein, when the second moving member operates in the fifth mode, the third optical member reflects a portion of the second transmitted light corresponding to the third reflectivity as fourth reflected light, and converts a remaining portion of the second transmitted light excluding the fourth reflected light into a fifth output light having a fifth output, and the fourth optical member reflects a portion of the fourth reflected light corresponding to the fourth reflectivity as fifth reflected light, and transmits a remaining portion of the fourth reflected light excluding the fifth reflected light as fourth transmitted light, and
wherein the light converter further includes a third absorbing member absorbing the fourth transmitted light and a fourth absorbing member absorbing the fifth reflected light.

13. The laser processing apparatus of claim 11,
wherein, when the second moving member operates in the sixth mode, the fourth optical member reflects a portion of the second transmitted light corresponding to the fourth reflectivity as sixth reflected light, and transmits a remaining portion of the second transmitted light excluding the sixth reflected light as a sixth output light having a sixth output, and
wherein the light converter further includes a third absorbing member absorbing the sixth reflected light.

14. A laser processing apparatus comprising:
a beam generator generating incident light; and
a light converter arranged in an optical path of the incident light and converting the incident light into one of first output light having a first output and second output light having a second output different from the first output,
wherein the light converter includes:
a first optical member having a first reflectivity, reflecting a portion of the incident light corresponding to the first reflectivity as first reflected light, and transmitting a remaining portion of the incident light excluding the first reflected light as first transmitted light;
a first mirror totally reflecting the first reflected light and outputting second reflected light;
a second mirror totally reflecting the first transmitted light and outputting third reflected light;
a second optical member having a second reflectivity different from the first reflectivity and arranged on a downstream side of the first mirror and the second mirror; and
a third mirror movable between a first position and a second position, and
wherein the first position does not overlap with an optical path of the second reflected light or the third reflected light, and the second position overlaps with the optical path of the second reflected light or the third reflected light.

15. The laser processing apparatus of claim 14,
wherein, when the third mirror is disposed at the first position, the second reflected light is irradiated onto a first surface of the second optical member, and the third reflected light is irradiated onto a second surface of the second optical member,
wherein the second optical member reflects a portion of the second reflected light, incident onto the first surface, corresponding to the second reflectivity as fourth reflected light, and transmits a remaining portion of the second reflected light excluding the fourth reflected light as second transmitted light,
wherein the second optical member further reflects a portion of the third reflected light, incident onto the second surface, corresponding to the second reflectivity as fifth reflected light, and transmits a remaining portion of the third reflected light excluding the fifth reflected light as third transmitted light, and
wherein the second optical member collects the fourth reflected light and the third transmitted light to output the first output light.

16. The laser processing apparatus of claim 15, further comprising:
a first absorbing member absorbing the second transmitted light and the fifth reflected light.

17. The laser processing apparatus of claim 15,
wherein, when the third mirror is disposed at the second position, the second reflected light is irradiated onto the first surface of the second optical member,
wherein the second optical member reflects a portion of the second reflected light, incident onto the first surface, corresponding to the second reflectivity as the fourth reflected light, and transmits a remaining portion of the second reflected light excluding the fourth reflected light as the second transmitted light, and
wherein the second optical member outputs the fourth reflected light as the second output light.

18. The laser processing apparatus of claim 17,
wherein the third mirror totally reflects the third reflected light, and
wherein the laser processing apparatus further includes a second absorbing member absorbing the third reflected light reflected from the third mirror.

19. A laser processing apparatus comprising:
a beam generator generating incident light; and
a light converter arranged in an optical path of the incident light and converting the incident light into one of first output light having a first output and second output light having a second output different from the first output,
wherein the light converter includes:
a first optical member movable between a first posture for converting the incident light into first reflected light directed in a first direction, and a second posture for converting the incident light into second reflected light directed in a second direction different from the first direction;
a second optical member having a reflectivity and overlapping the first optical member along the second direction; and
a third optical member disposed between the first optical member and the second optical member in an optical path, and totally reflecting the first reflected light in a direction toward the second optical member when the first optical member is in the first posture,
wherein, when the first optical member is in the first posture, the second optical member reflects a portion of the first reflected light, output from the third optical member, corresponding to the reflectivity as the first output light, and transmits a remaining portion of the first reflected light excluding the first output light as transmitted light, and
wherein, when the first optical member is in the second posture, the second optical member reflects a portion of the second reflected light corresponding to the reflectivity as third reflected light, and transmits a remaining portion of the second reflected light excluding the third reflected light as the second output light.

20. The laser processing apparatus of claim 19, further comprising:
an absorbing member absorbing the transmitted light when the first optical member is in the first posture and absorbing the third reflected light when the first optical member is in the second posture.
